(19) United States
(12) Patent Application Publication
(10) Pub. No.: US 2015/0285418 A1
(43) Pub. Date: Oct. 8, 2015

(54) JOINT FOR TUBE

(71) Applicant: Caterpillar Inc., Peoria, IL (US)

(72) Inventor: Carl H. Rempert, Shorewood, IL (US)

(73) Assignee: Caterpillar Inc., Peoria, IL (US)

(21) Appl. No.: 14/243,147

(22) Filed: Apr. 2, 2014

(51) Int. Cl. F16L 23/18; F16L 23/036; F16L 27/02; F16L 23/02

(52) U.S. Cl. CPC F16L 23/18; F16L 23/02; F16L 23/036; F16L 27/02

(57) ABSTRACT

A joint for a tube is provided. The joint includes a flange member including an aperture therethrough. The joint further includes a connecting member received at least partly within the aperture of the flange member. The connecting member includes a first portion retained within the aperture. The first portion includes a substantially spherical segmental surface rotatable relative to the flange member. The connecting member includes a second portion extending from the first portion, wherein the second portion is substantially tubular.

### TECHNICAL FIELD

The present disclosure relates to a joint and more particularly to a joint for a tube.

### BACKGROUND

Tube assemblies are used in various hydraulic, pneumatic and structural joints. Typically, in joints having fixed tube ends, a tube end is rigidly coupled to the joint. The joints require orientation to be aligned to the bends in a tube. A template and/or a jig may be used to assist in the orientation of the joints. However, a single template and/or jig may be used for only one type of tube assembly due to specific requirements of the particular tube assembly. Therefore, multiple templates and/or jigs have to be provided for various types of tube assemblies. Further, storage, transport and maintenance of the templates and/or jigs may also be required. Consequently, costs associated with the assembly may increase.

Typically, joints including a captive member slidably disposed within a flange member do not require orientation of the joint to the bends in the tube. Also, the flange member includes a retaining structure which restricts dis-assembly of the captive member from the flange member. The tube is coupled to the captive member. However, the captive member may slide freely on the tube until the tube is installed and the joint is coupled with the external system. This results in a damage of the paint and/or protective coating on the tube due to interaction of the tube with the captive member.

U.S. Pat. No. 6,419,279 discloses a ball and socket misalignment coupling. The ball and socket misalignment coupling includes a socket flange, ball member, retaining flange, threaded studs, and threaded retaining rings of limited shear strength. The threaded retaining rings function to permit the coupling to be pre-assembled. When the pre-assembled coupling is installed into service by using the threaded studs and associated nuts to bolt the coupling to a standard flange, the threaded rings are stripped out and remain in the assembly without obstructing the function of the coupling. The threaded retaining rings fit into recesses in the flanges through which the studs insert. The threaded retaining rings may made as a single-piece construction made from a material that has a yield and shear strength lower than that of the threaded studs about which they are mounted, or may be made as a two-piece threaded ring having inner threaded portion and a separate outer portion, each with differing material construction. The materials of the two pieces preferably are selected so that once the threaded region strips, the outer geometry can be used as a standard washer.

### SUMMARY

In one aspect, the present disclosure provides a joint for a tube. The joint includes a flange member including an aperture therethrough. The joint further includes a connecting member received at least partly within the aperture of the flange member. The connecting member includes a first portion retained within the aperture. The first portion includes a substantially spherical segmental surface rotatable relative to the flange member. The connecting member further includes a second portion extending from the first portion, wherein the second portion is substantially tubular.

In another aspect, the present disclosure provides a joint for a tube. The joint includes a flange member. The flange member includes a body portion and an intermediate portion coupled to the body portion. The intermediate portion includes an aperture therethrough. The joint further includes a connecting member received at least partly within the aperture of the intermediate portion. The connecting member includes a first portion retained within the aperture. The first portion includes a substantially spherical segmental surface rotatable relative to the flange member. The connecting member further includes a second portion extending from the first portion. The second portion is substantially tubular.

Other features and aspects of this disclosure will be apparent from the following description and the accompanying drawings.

### BRIEF DESCRIPTION OF THE DRAWINGS

FIG. 1 illustrates an exemplary tube assembly;

FIG. 2 illustrates an exploded view of a joint associated with the tube assembly of FIG. 1, according to an embodiment of the present disclosure;

FIG. 3 illustrates a cross-sectional view of the joint of FIG. 2;

FIG. 4 illustrates a cross-sectional view of the joint, according to another embodiment of the present disclosure;

FIG. 5 illustrates a cross-sectional view of the joint, according to yet another embodiment of the present disclosure;

FIG. 6 illustrates a cross-sectional view of the joint 604, according to a further embodiment of the present disclosure;

FIG. 7 illustrates a cross-sectional view of the joint 704, according to yet another embodiment of the present disclosure;

FIG. 8 illustrates a cross-sectional view of the joint 804, according to another embodiment of the present disclosure; and

FIGS. 9 and 10 illustrate cross-sectional views of the joint of FIG. 4 in multiple exemplary configurations.

### DETAILED DESCRIPTION

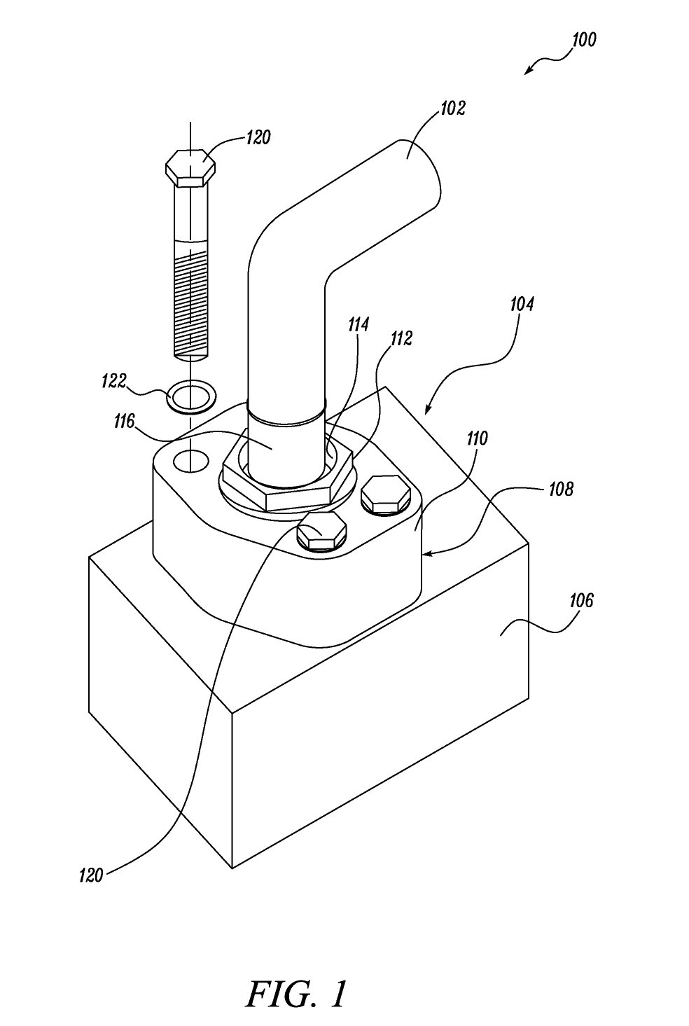

The present disclosure relates to a joint and more particularly to a joint for a tube. References will now be made in detail to specific embodiments or features, examples of which are illustrated in the accompanying drawings. Wherever possible, the same reference numbers will be used throughout the drawings to refer to the same or like parts. FIG. 1 illustrates an exemplary tube assembly 100. The tube assembly 100 includes a tube 102, a joint 104 and an external system 106. The tube 102 may be rigidly coupled to the joint 104 through commonly known means such as welding, threaded coupling, and the like. The tube 102 may be configured to carry fluid in the liquid state. Alternatively, the tube 102 may be configured to carry fluid in the gaseous state. Accordingly, the external system 106 may be a hydraulic, or a pneumatic system, such as, but not limited to a fluid valve, a port, a hydraulic cylinder, a pneumatic cylinder, or the like. Further, the external system 106 may be provided in a machine, a vehicle, or other application areas employing hydraulic and/or pneumatic components. In various alternative embodiments, the joint 104 may also be employed to couple a structural tube to the external system 106.

The joint 104 operatively couples the tube 102 to the external system 106. The joint 104 includes a flange member 108. The flange member 108 includes a body portion 110 and an intermediate portion 112. The intermediate portion 112 includes an aperture 114 therethrough. The joint 104 further includes a connecting member 116 received at least partly within the aperture 114 of the intermediate portion 112. The body portion 110 includes a fastening hole 118. As illustrated in FIG. 1 the body portion 110 includes four fastening holes 118 disposed circumferentially around the aperture 114. The fastening holes 118 are configured to receive respective fasteners 120 for coupling the flange member 108 to the external system 106. The fasteners 120 may be one of threaded bolts or screws provided with respective washers 122. The external system 106 may include one or more bolt holes (not shown) corresponding to the fastening holes 118 on the flange member 108 to allow coupling of the flange member 108 to the external system 106. The one or more bolt holes may have internal threads to couple with the fasteners 120. An O-ring (not shown) or any sealing device may be provided between the flange member 108 and the external system 106. The O-ring may define a circular cross-section, and is designed to be seated between the flange member 108 and the external system 106, and compressed during their assembly to allow a leak-resistant coupling therebetween.

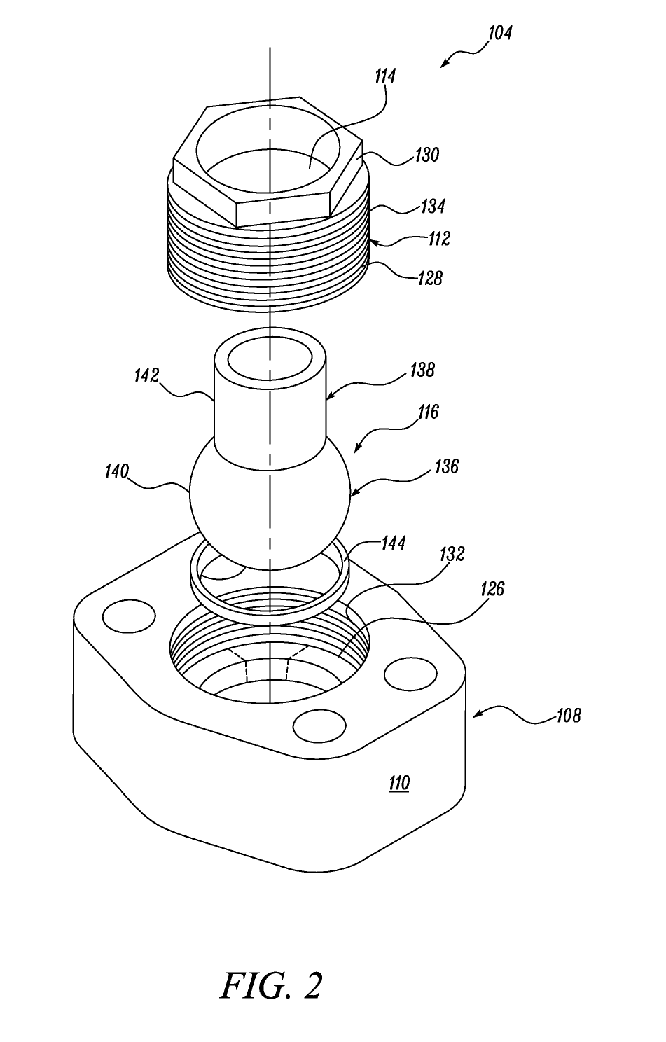

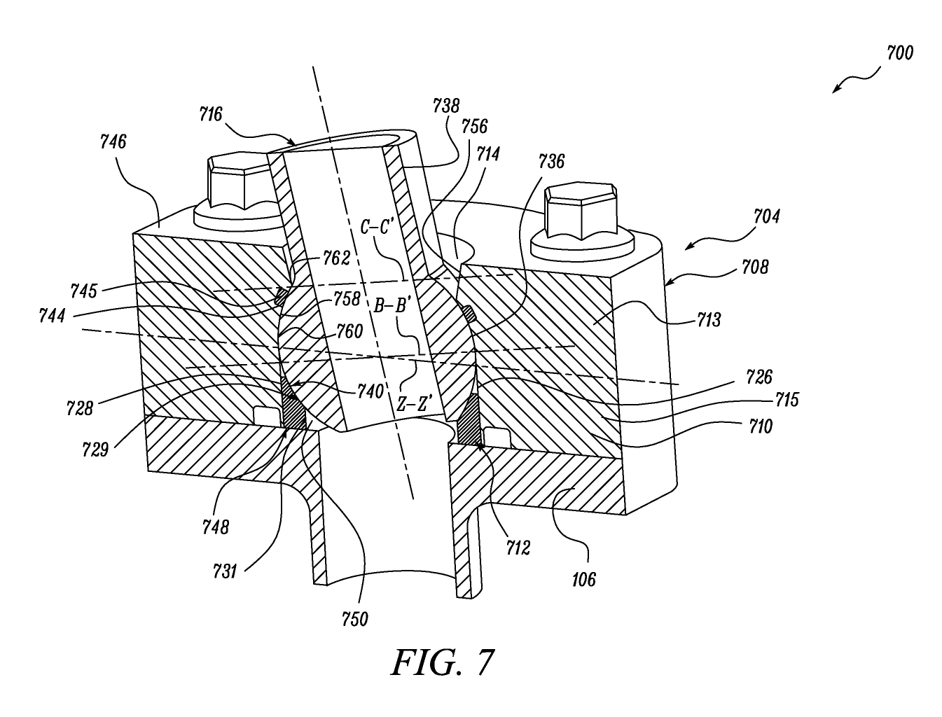

FIG. 2 illustrates an exploded view of the joint 104 associated with the tube assembly 100 of FIG. 1, according to an embodiment of the present disclosure. The body portion 110 defines a first cavity 126. The intermediate portion 112 is received at least partly within the first cavity 126. The intermediate portion 112 includes an attachment portion 128 and a collar 130 extending from the attachment portion 128. The first cavity 126 may include internal threads 132, and the attachment portion 128 of the intermediate portion 112 may include external threads 134 such that the intermediate portion 112 may be coupled to the body portion 110 by a threaded connection. Alternatively, the intermediate portion 112 may be coupled to the body portion 110 by an interference fit (shown in FIG. 7). It may apparent to a person skilled in the art that the threaded connection, and the interference fit referred herein are merely exemplary in nature, and thus non-limiting to this disclosure. One may contemplate other methods of coupling the intermediate portion 112 to the body portion 110, such as but not limited to, snap-fit coupling, welding, and adhesives.

The connecting member 116 includes a first portion 136 and a second portion 138 extending from the first portion 136. In an embodiment, the first portion 136 and the second portion 138 are integral. The first portion 136 is retained within the aperture 114. Further, the first portion 136 includes a substantially spherical segmental surface 140 rotatable relative to the flange member 108. The second portion 138 is substantially tubular 142. A sealing member 144, such as an O-ring, may be provided between the intermediate portion 112 and the first portion 136 of the connecting member 116.

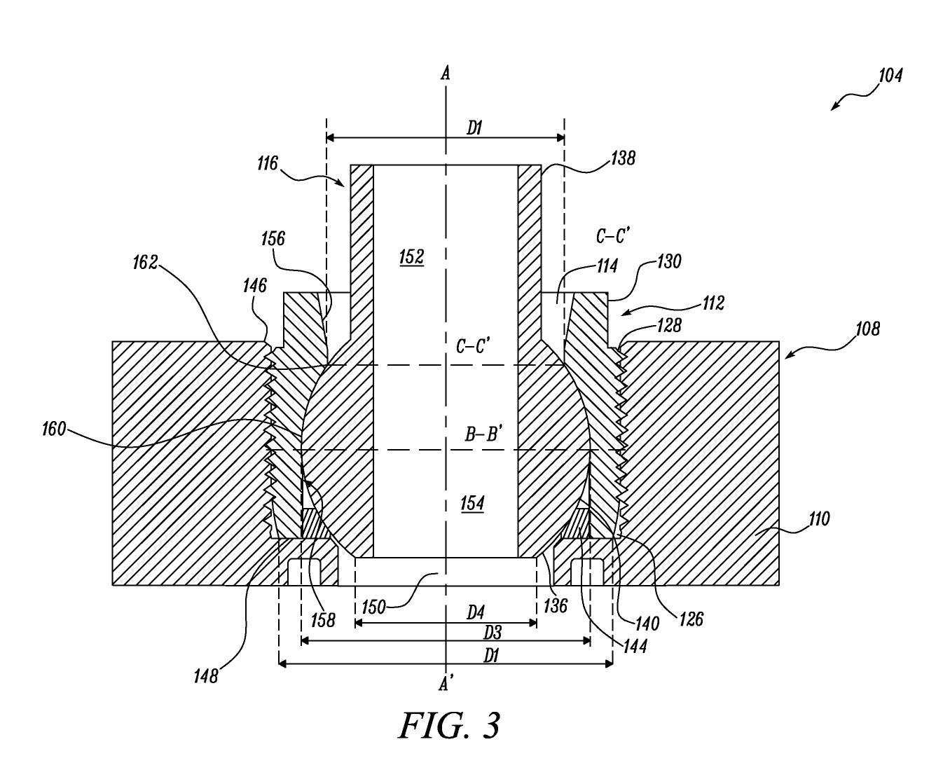

FIG. 3 illustrates a cross-sectional view of the joint 104 of FIG. 2. The first cavity 126 defines a top surface 146 and a bottom surface 148. The attachment portion 128 of the intermediate portion 112 is received between the top surface 146 and the bottom surface 148 of the first cavity 126. The body portion 110 further includes a second cavity 150 extending from the bottom surface 148 of the first cavity 126. In an embodiment, the first portion 136 and the second portion 138 include co-axial channels 152, and 154 therethrough, extending along an axis A-A′. The second cavity 150 associated with the body portion 110 may be co-axial with the channels 152, 154 of the first portion 136 and the second portion 138 respectively.

The intermediate portion 112 includes a substantially conical surface 156 followed by a retaining surface 158. The retaining surface 158 is configured to retain the first portion 136 of the connecting member 116 within the aperture 114. The retaining surface 158 may have a partly curvilinear cross-section 160. The retaining surface 158 and the conical surface 156 converge to form a retaining edge 162. Further, due to the substantially spherical segmental surface 140 of the first portion 136, the first portion 136 has a maximum diameter (D1) at a section B-B′ and a smaller diameter (D2) at a section C-C′. The retaining edge 162 abuts the first portion 136 at the section C-C′. Thus, due to the abutment of the retaining edge 162 with the first portion 136 along the section C-C′, a longitudinal movement of the connecting member 116 along the axis A-A′ may be substantially prevented. Further, a surface of the sealing member 144 may be chamfered to conform to the spherical segmental surface 140 of the first portion 136. Thus, the sealing member 144 provided at the bottom surface 148 of the first cavity 126 may also retain the first portion 136 within the aperture 114.

As shown in FIG. 3, the first portion 136 may partly abut the curvilinear cross-section 160 of the intermediate portion 112. The first portion 136 may rotate relative to the flange member 108 due to the abutment of the curvilinear cross-section 160 of the retaining surface 158, and the substantially spherical segmental surface 140 of the first portion 136. When the joint 104 is coupled to the external system 106 (not shown), the second cavity 150 provides a clearance between the joint 104 and the external system 106. The second cavity 150 has a diameter (D3) which is greater than the diameter (D4) of a section of the first portion 136. Due to the diameter (D3) of the second cavity 150, the first portion 136 may be partly accommodated within the second cavity 150 upon rotation of the connecting member 116 within the aperture 114.

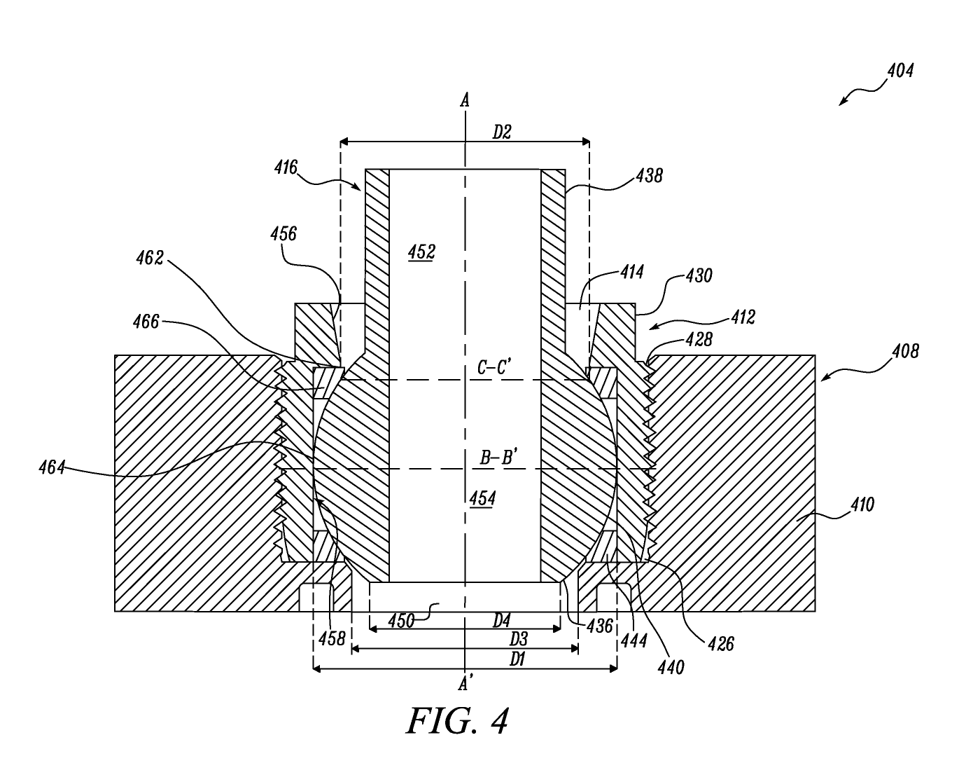

FIG. 4 illustrates a cross-sectional view of the joint 404, according to another embodiment of the present disclosure. The retaining surface 458 of the intermediate portion 412 may have a substantially linear cross-section 464. Although, the conical surface 456 and the retaining surface 458 may converge to form the retaining edge 462, an additional sealing member 466 may be provided adjacent the retaining edge 462. The additional sealing member 466 abuts the first portion 436 at the section C-C′. Thus, due to the abutment of the additional sealing member 466 with the first portion 436 along the section C-C′, a longitudinal movement of the connecting member 416 along the axis A-A′ may be substantially prevented. Further, a surface of the sealing member 444 and the additional sealing member 466 may be chamfered to conform to the spherical segmental surface 440 of the first portion 436. The sealing member 444 provided at the bottom surface 448 of the first cavity 426 may also retain the first portion 436 within the aperture 414.

Furthermore, a clearance for rotation of the first portion 436 relative to the flange member 408 may be provided due to the substantially linear cross-section 464 of the retaining surface 458, and the substantially spherical segmental surface 440 of the first portion 436. When the joint 404 is coupled to the external system 106 (not shown), the second cavity 450 provides a clearance between the joint 404 and the external system 406. The second cavity 450 has a diameter (D3) which is greater than the diameter (D4) of a section of the first portion 436. Due to the diameter (D3) of the second cavity 450, the first portion 436 may be partly accommodated within the second cavity 450 upon rotation of the connecting member 416 within the aperture 414. However, in an alternative embodiment, the intermediate portion 412 may be integral to the body portion 410 of the joint 404.

Although, a curvilinear cross-section 160, 460, and a substantially linear cross-section 164, 464 are disclosed in conjunction with the embodiments depicted in FIGS. 3 and 4, respectively, it is to be noted that the depicted cross-sections may be interchangeably provided in the other embodiments of the present disclosure as well. Further, a person ordinarily skilled in the may contemplate other suitable cross-section that may be used in lieu of the curvilinear and the linear cross-sections 160, 460, 164, 464 for implementation of the present disclosure.

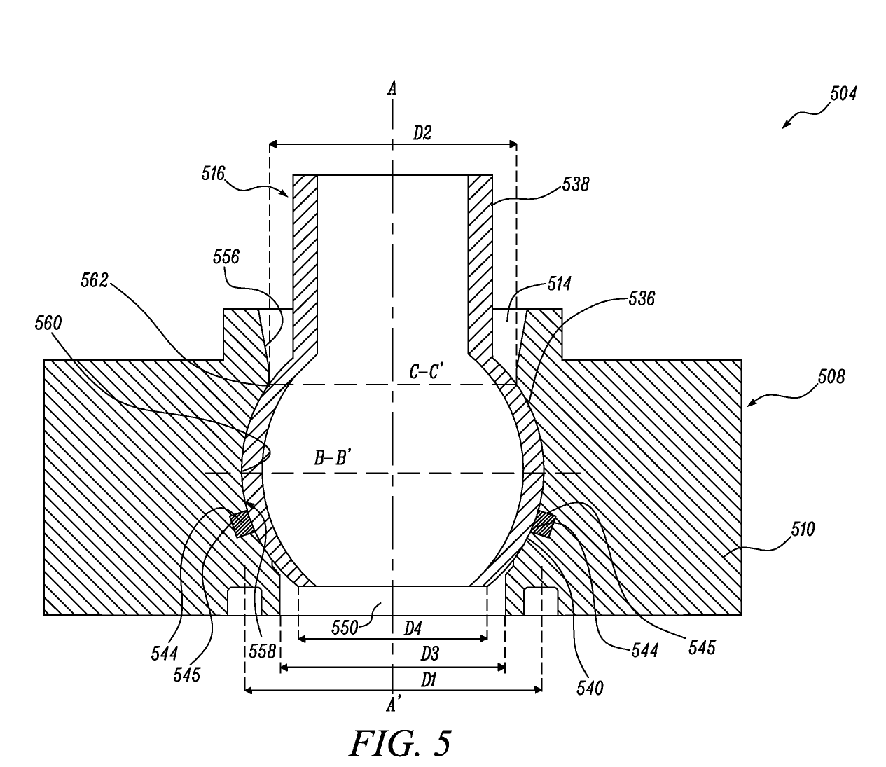

FIG. 5 illustrates a cross-sectional view of the joint 504, according to yet another embodiment of the present disclosure. The joint 504 includes the flange member 508 having the aperture 514 therethrough. The joint 504 further includes the connecting member 516 received at least partly within the aperture 514 of the flange member 508. The connecting member 516 includes the first portion 536 retained within the aperture 514, and the second portion 538 extending from the first portion 536. As shown in FIG. 5, the first portion 536 and the second portion 538 of the connecting member 516 may be integrally formed. This may be accomplished by cold forming the first portion 536 from a straight tubular section. The straight tubular section is inserted into the aperture 514 of the flange member 508. A portion of the straight tubular section is cold formed against the retaining surface 558 of the flange member 508 in order to make the spherical segmental surface 540 of the first portion 536. The remaining tubular portion of the straight tubular section extends from the first portion 536 as the second portion 538 of the connecting member 516.

The aperture 514 defines the first cavity 526 and the second cavity 550. The flange member 508 includes the substantially conical surface 556 followed by the retaining surface 558. The retaining surface 558 is configured to retain the first portion 536 of the connecting member 516 within the aperture 514. The retaining surface 558 and the conical surface 556 converge to form the retaining edge 562. In the embodiment, as shown in FIG. 5, the retaining surface 558 may have the partly curvilinear cross-section 560 which conforms to the substantially spherical segmental surface 540 of the first portion 536. A groove 545 may be provided at the bottom surface 548. The sealing member 544 may be disposed within the groove 545 provided at the bottom surface 548 of the first cavity 526. Hence, a longitudinal movement of the connecting member 516 along the axis A-A′ may be substantially prevented, and a rotational motion of the connecting member 516 relative to the flange member 508 may be allowed similar to the manner explained with reference to FIG. 3. In the embodiment as shown in FIG. 5, the groove 545 is a transverse groove such that a surface of the sealing member 544 may conform to the substantially spherical segmental surface 540 of the first portion 536 to allow a leak resistant coupling therebetween. However, in alternative embodiments, the groove 545 may be a linear groove and a surface of the sealing member 544 may be chamfered. Thus the sealing member 544 may conform to the substantially spherical segmental surface 540 of the first portion 536 to allow a leak resistant coupling therebetween.

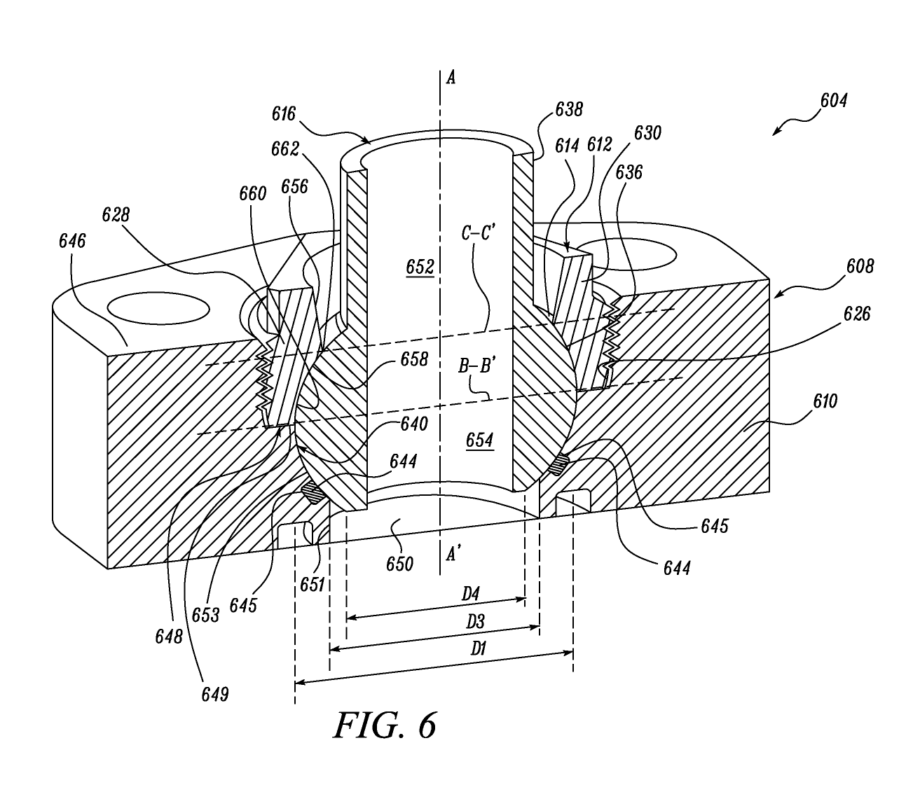

FIG. 6 illustrates a cross-sectional view of the joint 604, according to a further embodiment of the present disclosure. The connecting member 616 includes the first portion 636 and the second portion 638 extending from the first portion 636. The body portion 610 defines the first cavity 626. The intermediate portion 612 is received at least partly within the first cavity 626. The intermediate portion 612 includes the attachment portion 628 and the collar 630 extending from the attachment portion 628. The first cavity 626 includes the top surface 646 and the bottom surface 648. The bottom surface 648 includes a top end 649 and a bottom end 651. The attachment portion 628 of the intermediate portion 612 is received between the top surface 646 of the first cavity 626 and the top end 649 of the bottom surface 648 of the first cavity 626. An interface surface 653 extends between the top end 649 and the bottom end 651 of the bottom surface 648. The interface surface 653 may also define the partly curvilinear cross-section 660. The body portion 610 further includes the second cavity 650 extending from the bottom end 651 of the bottom surface 648 of the first cavity 626. The second cavity 650 may be co-axial with the channels 652, 654 of the first portion 636 and the second portion 638 respectively.

The intermediate portion 612 includes the substantially conical surface 656 followed by the retaining surface 658. The retaining surface 658 is configured to retain the first portion 636 of the connecting member 616 within the aperture 614. The retaining surface 658 may have the partly curvilinear cross-section 660. The retaining surface 658 and the conical surface 656 converge to form the retaining edge 662. Further, due to the substantially spherical segmental surface 640 of the first portion 636, the first portion 636 has a maximum diameter (D1) at a section B-B′ and a smaller diameter (D2) at a section C-C′. The retaining edge 662 abuts the first portion 636 at the section C-C′. Thus, due to the abutment of the retaining edge 662 with the first portion 636 along the section C-C′, a longitudinal movement of the connecting member 616 along the axis A-A′ may be substantially prevented. Further, the groove 645 may be provided at the bottom end 651 to accommodate the sealing member 644 therein. Thus, the sealing member 644 provided at the bottom end 651 of the bottom surface 648 may also retain the first portion 636 within the aperture 614.

As shown in FIG. 6, the first portion 636 may partly abut the curvilinear cross-section 660 of the intermediate portion 612, and partly abut the curvilinear cross-section 660 the interface surface 653. The first portion 636 may rotate relative to the flange member 608 due to abutment of the curvilinear cross-section 660 of the retaining surface 658 and the curvilinear cross-section 660 of the interface surface 653 with the substantially spherical segmental surface 640 of the first portion 636. When the joint 604 is coupled to the external system 106 (not shown), the second cavity 650 provides a clearance between the joint 604 and the external system 606. The second cavity 650 has a diameter (D3) which is greater than the diameter (D4) of a section of the first portion 636. Due to the diameter (D3) of the second cavity 650, the first portion 636 may be partly accommodated within the second cavity 650 upon rotation of the connecting member 616 within the aperture 614.

FIG. 7 illustrates a cross-sectional view of the joint 704, according to yet another embodiment of the present disclosure. The connecting member 716 includes the first portion 736 and the second portion 738 extending from the first portion 736. The body portion 710 defines the first cavity 726. The first cavity 726 includes the top surface 746 and the bottom surface 748. The top surface 746 of the first cavity 726 defines the substantially conical surface 656 followed by the retaining surface 758. The retaining surface 758 is configured to retain the first portion 736 of the connecting member 716 within the first cavity 726. The retaining surface 758 may have the partly curvilinear cross-section 760. The retaining surface 758 and the conical surface 756 converge to form the retaining edge 762. As shown in FIG. 7, the groove 745 may be provided near the retaining edge 762 of the first cavity 726 to accommodate the sealing member 744 therein.

The intermediate portion 712 is received at least partly within the first cavity 726 and defines the aperture 714 therethrough. In an embodiment, the intermediate portion 712 may be retained within the first cavity 726 of the body portion 710 by an interference fit. The intermediate portion 712 includes the attachment portion 728. The attachment portion 728 is received at the bottom surface 748 of the first cavity 726. The attachment portion 728 may include a chamfered surface 729 and a linear surface 731. The chamfered surface 729 may conform to the spherical segmental surface 740 of the first portion 736. When the chamfered surface 729 of the attachment portion 728 abuts the first portion 736, the linear surface 731 defines the second cavity 750 due to the substantially spherical segmental surface 740 of the first portion 736.

The first portion 736 has a maximum diameter (D1) at a section B-B′ and a smaller diameter (D2) at a section C-C′. The retaining edge 762 abuts the first portion 736 at the section C-C′. Thus, due to the abutment of the retaining edge 762 with the first portion 736 along the section C-C′, a longitudinal movement of the connecting member 716 along the axis A-A′ may be substantially prevented. As shown in FIG. 7, the first portion 736 may partly abut the curvilinear cross-section 760 of the first cavity 726, and partly abut the chamfered surface 729 of the attachment portion 728. The first portion 736 may rotate relative to the flange member 708 due to the abutment of the curvilinear cross-section 760 of the retaining surface 758 and the attachment portion 728 with the substantially spherical segmental surface 740 of the first portion 736. When the joint 704 is coupled to the external system 106, the second cavity 750 provides the clearance between the joint 704 and the external system 706. The second cavity 750 has a diameter (D3) which is greater than the diameter (D4) of a section of the first portion 736. Due to the diameter (D3) of the second cavity 750, the first portion 736 may be partly accommodated within the second cavity 750 upon rotation of the connecting member 716 within the aperture 714.

In an embodiment, the flange member 708 may be a split flange, i.e., the flange member 708 may be split axially about the section Z-Z′. The flange member 708 thus includes a first flange 713 and a second flange 715. The connecting member 716 may be received within the first cavity 726 when the first flange 713 and the second flange 715 are not bolted together. After receiving the connecting member 716, the intermediate portion 712 may be accommodated within the aperture. Following this, the first flange 713, the second flange 715 and the external system 106 may be bolted together. However, in alternative embodiment, the connecting member 716 may be accommodated within the first cavity 726 by removing the intermediate portion 712 from the first cavity 726. After receiving the connecting member 716 in the first cavity 726, the intermediate portion 712 may be accommodated in the first cavity 726 and the joint 704 may then be bolted to the external system 106.

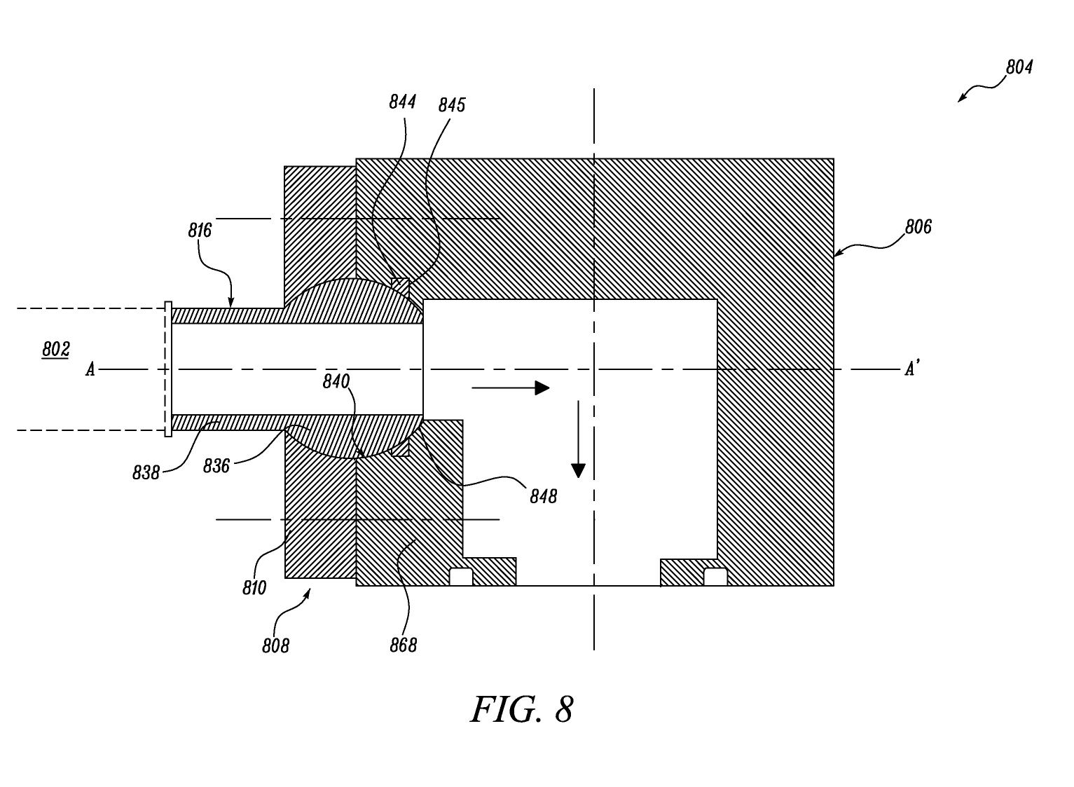

In an embodiment, the joint 104 of the present disclosure may be employed for coupling the tube 102 to an elbow member 868 associated with the external system 106. FIG. 8 illustrates a cross-sectional view of the joint 804, according to another embodiment of the present disclosure. The flange member 808 may be coupled to the elbow member 868 through threaded fasteners 820 (not shown). The elbow member 868 may be configured to allow a change in a direction of flow of the liquid and/or gas communicating between the joint 804 and the external system 106. Since the first portion 836 is shown to be interference fitted within the first cavity 826, the groove 845 may be provided at the bottom surface 848 in a manner as explained in FIG. 5. The sealing member 844 may be disposed within the groove 845 provided at the bottom surface 848 of the first cavity 826.

Although, it is disclosed herein that the joint 104, 404, 504, 604, 704, 804 may be implemented in various hydraulic, pneumatic, and structural couplings, and in lateral and orthogonal orientations, a person having ordinary skill in the art may acknowledge that the implementation of the joint 104, 404, 504, 604, 704, 804 with respect to the application areas disclosed herein and various orientations as depicted through the respective figures are merely exemplary in nature and hence, non-limiting of this disclosure. Any machine and/or industry employing tubes for transmission of fluid in liquid and/or gaseous phase, or for coupling structural tube components may employ the joint 104, 404, 504, 604, 704, 804 disclosed herein. Further, it is to be noted that various cross-sections and designs of the components such as the connecting member 116, 416, 516, 616, 716, the intermediate portion 112, 412, 512, 612, 712 the first cavity 126, 426, 526, 626, 726, 826, the groove 545, 645, 745, 845, and the sealing member 144, 444, 544, 644, 744, 844 as explained with reference to specific embodiments, may be conveniently provided with other embodiments of the present disclosure as well. For example, in all the embodiments, the connecting member 116, 416, 516, 616, 716 may be formed by receiving the second portion 138, 438, 538, 638, 738, 838 within the first portion 136, 436, 536, 636, 736, 836. Further, the attachment portion 128, 428, 528, 628, 728 of the intermediate portion 112, 412, 512, 612, 712 as explained in FIG. 5 may be employed in other embodiments as well.

### INDUSTRIAL APPLICABILITY

Conventional tube assemblies require additional jigs/fixtures for orientation of a joint to the bends of the tube, and for alignment of one or more bolt holes disposed on the joint to corresponding bolt holes provided on an external system. As discussed in the present disclosure, the first portion 136 associated with the connecting member 116 is retained within the aperture 114 of the flange member 108 and is rotatable with respect to the flange member 108. During coupling of the joint 104 to the external system 106, the flange member 108 may be rotated to align the fastening holes 118 disposed on the body portion 110 to the bolt holes disposed on the external system 106.

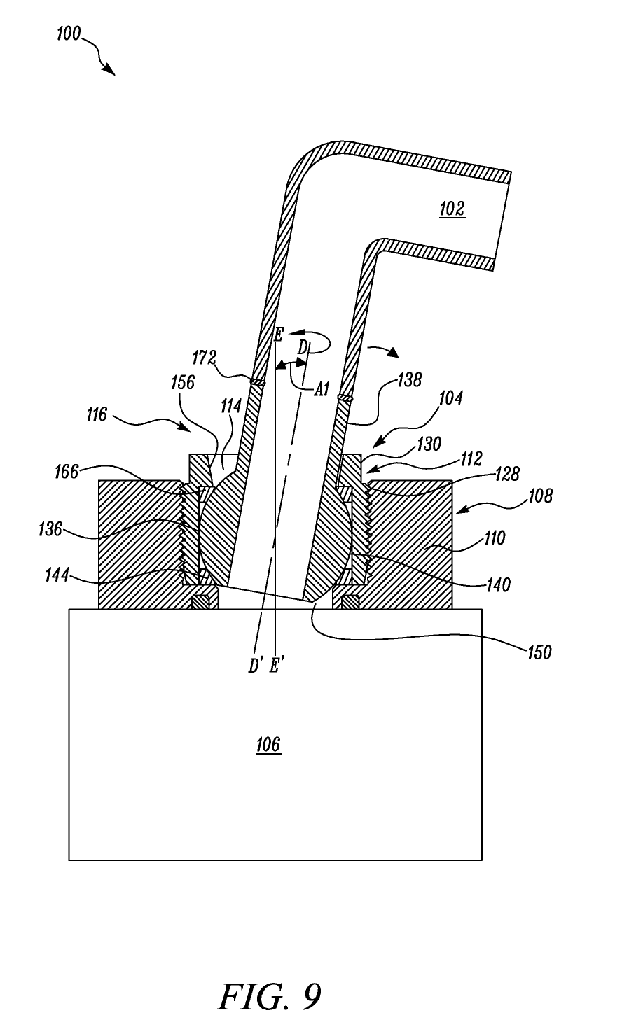

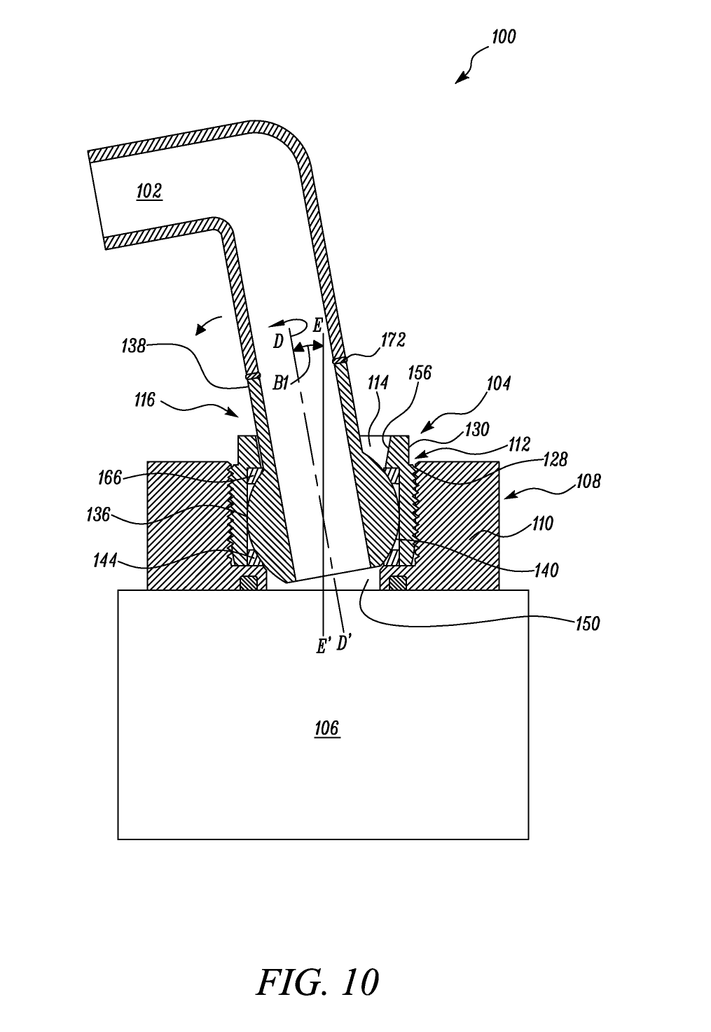

FIGS. 9 and 10 illustrate cross-sectional views of the joint 404 of FIG. 4 in multiple exemplary configurations. The joint 404 is shown to be coupled to a coupling surface 170 associated with the external system 106. The second portion 438 of the connecting member 416 may include a tube coupling surface 472 such that the tube 102 may be coupled to the joint 404 at the tube coupling surface 472. The axis A-A′ and D-D′ are shown for ease of explanation of a motion of the connecting member 416 within the aperture 414. The intermediate portion 412 includes the conical surface 456. The connecting member 416 may tilt in a clockwise direction and/or an anti-clockwise direction to abut the conical surfaces 456 provided on each end of the intermediate portion 412.

FIG. 9 illustrates the tube assembly 400 with the connecting member 416 being tilted in the clockwise direction. Due to the substantially spherical segmental surface 440 of the first portion 436, the connecting member 416 may also tilt within the aperture 414. The second cavity 450 provides the clearance to partly receive the first portion 436 upon tilting of the connecting member 416. The axis A-A′ makes an angle (A1) with the axis D-D′. The angle A1 is indicative of a clockwise angular range of the connecting member 416 with respect to the external system 406. FIG. 10 illustrates the tube assembly 400 with the connecting member 416 being tilted in the anti-clockwise direction. The connecting member 416 may tilt within the aperture 414 similar to as explained in FIG. 8. The axis A-A′ makes an angle (B1) with the axis D-D′. The angle B1 is indicative of an anti-clockwise angular range of the connecting member 416 with respect to the external system 106. The total angular range of movement of the connecting member 116 with respect to the external system 106 is a sum of the angles A1 and B1. In various embodiments, the angle A1 and B1 may be substantially same, angle A1 may be greater than angle B1, or angle B1 may be greater than A1. In an exemplary embodiment, the total angular range of movement of the connecting member 116 with respect to the external system 106 may be between 2 degrees to 25 degrees.

Therefore, along with the rotational movement of the first portion 136, 436, 536, 636, 736 within the aperture 114, 414, 514, 614, 714 the connecting member 116, 416, 516, 616, 716 additionally has an increased degree of freedom due to the tilt motion of the second portion 138, 438, 538, 638, 738 within the aperture 114, 414, 514, 614, 714 i.e., the second portion 138, 438, 538, 638, 738 has a wider angular range of displacement about the axes D-D′. It is to be noted that the connecting member 116, 416, 516, 616, 716 may articulate within the aperture 114, 414, 514, 614, 714 to orient the joint 104, 404, 504, 604, 704 to bends in the tube 102. Further, the flange member 108, 408, 508, 608, 708 may also articulate with respect to the connecting member 116, 416, 516, 616, 716. Thus, during coupling of the joint 104, 404, 504, 604, 704 to the external system 106, the joint 104, 404, 504, 604, 704 of the present disclosure may therefore allow the flange member 108, 408, 508, 608, 708 and the coupling surface 170 of the external system 106 to be substantially parallel to each other. Hence, sealing between the joint 104, 404, 504, 604, 704 and the external system 106 is increased. Moreover, with the joint 104, 404, 504, 604, 704 of the present disclosure, re-orientation of the connecting member 116, 416, 516, 616, 716 even after the joint 104, 404, 504, 604, 704 is coupled to the external system 106 is possible. Thus, the joint 104, 404, 504, 604, 704 provides for a greater flexibility to the tube assembly 100, 400.

In an alternative scenario where the joint 104, 404, 504, 604, 704 is not coupled to the external system 106, the tube 102 may be rigidly coupled to the joint 104, 404, 504, 604, 704 at the tube coupling surface 172. With the first portion 136, 436, 536, 636, 736 being retained within the aperture 114, 414, 514, 614, 714, a longitudinal movement of the connecting member 116, 416, 516, 616, 716 along the axis A-A′ is prevented. Thus, the connecting member 116, 416, 516, 616, 716 cannot slide over the tube 102 and damage to the paint on the tube 102 is prevented.

As explained in various embodiments of the present disclosure, components such as the intermediate portion 112, 412, 512, 612, 712 the connecting member 116, 416, 516, 616, 716, and the sealing member 144, 444, 544, 644, 744, 166, 466 associated with the joint 104, 404, 504, 604, 704 may be easily manufactured and assembled to form the joint 104, 404, 504, 604, 704. Thus, the joint 104, 404, 504, 604, 704 may be easily assembled. Further, the joint 104, 404, 504, 604, 704 may also be used with various types of tube assemblies.

From the foregoing it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

What is claimed is:

1. A joint for a tube, the joint comprising:
a flange member comprising an aperture therethrough;
a connecting member received at least partly within the aperture of the flange member, the connecting member comprising:
a first portion retained within the aperture, the first portion comprising a substantially spherical segmental surface rotatable relative to the flange member; and
a second portion extending from the first portion, wherein the second portion is substantially tubular.

2. The joint of claim 1, wherein the first portion and the second portion are integral.

3. The joint of claim 1, wherein the first portion and the second portion comprises co-axial channels therethrough.

4. The joint of claim 1, wherein the flange member further comprises a body portion and an intermediate portion coupled to the body portion, wherein the intermediate portion comprises the aperture therethrough.

5. The joint of claim 4, wherein the intermediate portion is coupled to the body portion by a threaded connection.

6. The joint of claim 4, wherein intermediate portion is coupled to the body portion by an interference fit.

7. The joint of claim 4, wherein the intermediate portion comprises a retaining surface configured to retain the first portion of the connecting member within the aperture.

8. The joint of claim 4 further including a sealing member provided between the intermediate portion and the first portion of the connecting member, the sealing member configured to retain the first portion of the connecting member within the aperture.

9. The joint of claim 8 further including a groove configured to receive the sealing member therein.

10. The joint of claim 1, wherein flange member comprises a fastening hole configured to receive a fastener therethrough, the fastener configured to couple the flange member to an external system.

11. A joint for a tube, the joint comprising:
a flange member comprising:
a body portion; and
an intermediate portion coupled to the body portion,
wherein the intermediate portion comprises an aperture therethrough; and
a connecting member received at least partly within the aperture of the flange member, the connecting member comprising:
a first portion retained within the aperture, the first portion comprising a substantially spherical segmental surface rotatable relative to the flange member; and
a second portion extending from the first portion, wherein the second portion is substantially tubular.

12. The joint of claim 11, wherein the first portion and the second portion are integral.

13. The joint of claim 11, wherein the first portion and the second portion comprises co-axial channels therethrough.

14. The joint of claim 11, wherein the intermediate portion is coupled to the body portion by a threaded connection.

15. The joint of claim 11, wherein intermediate portion is coupled to the body portion by an interference fit.

16. The joint of claim 11, wherein the intermediate portion comprises a retaining surface configured to retain the first portion of the connecting member within the aperture.

17. The joint of claim 11, further including a sealing member provided between the intermediate portion and the first portion of the connecting member, the sealing member configured to retain the first portion of the connecting member within the aperture.

18. The joint of claim 17 further including a groove configured to receive the sealing member therein.

19. The joint of claim 11, wherein flange member comprises a fastening hole configured to receive a fastener therethrough, the fastener configured to couple the flange member to an external system.

20. The joint of claim 18, wherein the sealing member is an O-ring.
